(19) United States
(12) Patent Application Publication
(10) Pub. No.: US 2021/0347511 A1
(43) Pub. Date: Nov. 11, 2021

(54) SHOCK-ABSORBING MATERIAL SUPPLY APPARATUS USED FOR ARTICLE PACKAGING DEVICE

(71) Applicant: CJ LOGISTICS CORPORATION, Seoul (KR)

(72) Inventor: Dae Yong KIM, Seoul (KR)

(21) Appl. No.: 17/274,203

(22) PCT Filed: Jan. 11, 2019
(86) PCT No.: PCT/KR2019/000489

§ 371 Date: Mar. 8, 2021

(30) Foreign Application Priority Data
Sep. 20, 2018 (KR) 10-2018-0112745

(51) Int. Cl. B65B 55/20; B65G 47/18

(52) U.S. Cl. CPC B65B 55/20; B65G 47/18

(57) ABSTRACT

The present invention relates to a shock-absorbing material supply apparatus used for a device-article packaging device for putting and packaging articles and a shock-absorbing material together in a packaging box. The present invention relates to the shock-absorbing material supply apparatus used for the article packaging device for filling the empty inner space of a packaging box B, into which articles are put, with the shock-absorbing material so as to package the articles, the apparatus comprising: a shock-absorbing material manufacturing device; a first hopper; a shock-absorbing material supply conveyor; a shock-absorbing material accommodation part; and a shock-absorbing material guide part.

### TECHNICAL FIELD

The present invention relates to a shock-absorbing material supply apparatus used for an article packaging device for packaging articles and a shock-absorbing material together in a packaging box. Particularly, the present invention relates to a shock-absorbing material supply apparatus used for an article packaging device that calculates in advance the volumes of packaging boxes in various difference sizes randomly conveyed on a conveyer and the volumes of articles to be put in the packaging boxes, checks the values calculated in advance and the volumes of empty spaces in the packaging boxes with the articles therein, and fills the packaging boxes with shock-absorbing materials corresponding to the volumes of the empty space.

### BACKGROUND ART

When an article is packaged in a packaging box, a shock-absorbing material is packaged together with the article in the packaging box to prevent the article from moving in the packaging box and from being damaged due to external shock when the package is transported.

Since such packaging of articles is manually performed by workers in the art, there is a problem that the efficiency of packaging is low. Further, it is difficult to measure and find out the accurate volume of the empty internal space left after a packaging box is filled with an article, so it is very difficult to fully and sufficiently fill the empty internal space of the packaging container with a shock-absorbing material. In order to solve this problem, apparatuses that measure the volume of the empty internal space of a packaging box with an article therein in various ways and then put a shock-absorbing material corresponding to the measured volume of the empty internal space in the packaging box have been disclosed.

For example, the following Patent Literature 1 is configured: to install a plurality of packaging lines (delivery networks) in which packaging is separately performed for the sizes or kinds of articles to be packaged, and the sizes of packaging boxes suitable for packaging the articles; to discriminate and distribute those kinds of packaging boxes separately to the packaging lines; to measure the volumes in the empty internal spaces of the packaging boxes (empty internal spaces left after the packaging boxes are filled with the articles) put into the packaging lines using sensors provided for the packaging lines, respectively; and to fill the packaging boxes with shock-absorbing materials corresponding to the measured volumes the empty internal spaces of the packaging boxes.

Since the packaging system of the Patent Literature 1 distributes packaging boxes having various sizes corresponding to the sizes of articles having various sizes to packaging lines (delivery networks) to package the articles, the scale of the entire system is large and complicated. Accordingly, the system is not suitable for a small-scale packaging facility that uses a small number of kinds of packaging boxes, for example, five or less kinds of packaging boxes for packaging.

Further, the Patent Literature 1 proposes a scanner 72 measuring the volumes of empty spaces (empty volumes) of packaging boxes conveyed on packaging lines, respectively. However, the empty volume scanner 72 of the Patent Literature 1 requires at least three independent sensors to measure the empty space of a container, that is, relatively many kinds of sensors such as a height sensor 82 of a container 80, a width sensor 84 of the container 80, and an outline sensor 86 detecting the volume of an article 16, and there are many features to be measured. Accordingly, the operating software becomes complicated and the entire device also becomes complicated. Therefore, there is a defect that a large amount of cost is required to construct the facility. Further, the Patent Literature 1 proposes a shock-absorbing material distribution device 14 that puts a shock-absorbing material into an empty space in a packaging box. The shock-absorbing material distribution device 14 of the patent document 1 is provided for each packaging line, so there is a problem that the scale of the entire packaging facility becomes large.

Further, it is difficult to quickly and accurately supply a shock-absorbing material into the empty internal space of a packaging box using a simple configuration.

A method of detecting the volume of empty internal spaces of various packaging boxes having different sizes and randomly conveyed in a conveyer and then putting shock-absorbing materials corresponding to the detected volume of the empty spaces into the packaging boxes of the present invention has been improved from the configuration disclosed in Korean Patent Application Publication No. 2017-0138335 by the applicant(s) and partially embodied from the configuration of the article packaging device and method disclosed in Korean Patent Application Publication No. 2018-0106546. Accordingly, the spirits of the prior applications can be applied to the present invention.

### CITATION LIST

### Patent Literature

[Patent Literature 1] KR 10-1224851B

### SUMMARY OF INVENTION

### Technical Problem

The present invention has been made in an effort to solve the problems of the packaging device and method described above, and an object of the present invention is to supply a shock-absorbing material corresponding to the volumes of empty internal space of packaging box by calculating in advance the volume of a packaging box and the volume of an article to be put into the packaging box and then checking the values calculated in advance and the volume of the empty internal space of the packaging box with the article therein.

Another object of the present invention is to solve the problems in Korean Patent Application No. 2017-0138335 by the applicant(s) that a device manufacturing and supplying a shock-absorbing material is complicated and shock-absorbing materials are oversupplied.

### Solution to Problem

The present invention has been made to achieve the objects and has the following configuration.

The present invention relates to (1) a shock-absorbing material supply apparatus that is used for an article packaging device that packages a shock-absorbing material in an empty internal space of a packaging box B with an article therein. The shock-absorbing material supply apparatus includes: a shock-absorbing material manufacturing device 410 manufacturing a shock-absorbing material; a first hopper 420 installed under the shock-absorbing material manufacturing device 410 and keeping manufactured shock-absorbing materials; a shock-absorbing material supply conveyer 430 installed under the first hopper 420 and supplying a predetermined amount of shock-absorbing materials to a second hopper 510; a shock-absorbing material receiver 520 being supplied with the shock-absorbing materials stored in the second hopper 510; and a shock-absorbing material guide 530 guiding the shock-absorbing materials received in the shock-absorbing material receiver 520 to empty internal spaces of packaging boxes B.

Further, the present invention relates to (2) the shock-absorbing material supply apparatus that is used for an article packaging device of (1) in which the shock-absorbing material supply conveyer 430 has guide plates 431 disposed with regular intervals such that a predetermined amount of shock-absorbing materials are separately conveyed to the second hopper 510.

Further, the present invention relates to (3) the shock-absorbing material supply apparatus that is used for an article packaging device of (2) in which the second hopper 510 is divided by several blades 511, and a blade cover 512 having a sufficient size that can cover a top inlet 521 of the shock-absorbing material receiver 520 is installed behind and under the blade 511.

Further, the present invention relates to (4) the shock-absorbing material supply apparatus that is used for an article packaging device of (3) in which the shock-absorbing material guide 530 has an upper portion that is larger in area than the shock-absorbing material receiver 520 and a lower portion that is smaller than the area of the top of a packaging box B such that all of shock-absorbing materials can be guided to the packaging box B from the shock-absorbing material receiver 520.

Further, the present invention relates to (5) the shock-absorbing material supply apparatus that is used for an article packaging device of (1) in which several first sensors S1 are installed up and down on a side of the first hopper 420 and the first sensors S1 measure the amount of shock-absorbing materials stored in the first hopper 420, show the amount to the outside, and transmit the amount to a controller.

Further, the present invention relates to (6) the shock-absorbing material supply apparatus that is used for an article packaging device of (1) in which second sensors S2 are installed on a side of the upper portion of the second hopper 510 and, when shock-absorbing materials are supplied up to the top of the second hoper 510, the second sensors are turned on and transmit a turning-on signal to a controller to stop the shock-absorbing material conveyer 430.

Further, the present invention relates to (7) the shock-absorbing material supply apparatus that is used for an article packaging device of (1) in which third sensors S3 are installed on a side of the upper portion of the shock-absorbing material receiver 520 and, when shock-absorbing materials are not received up to the top of the shock-absorbing material receiver 520, the third sensors S3 are turned off and transmit a turning-off signal to a controller to stop operation of the article packaging device.

Further, the present invention relates to (8) the shock-absorbing material supply apparatus that is used for an article packaging device of (1) in which the shock-absorbing material receiver 520 is formed in a cylindrical shape, a shock-absorbing material support plate 522 moving up and down is installed inside the shock-absorbing material receiver 520, the shock-absorbing material support plate 522 is moved up and down by a first LM guide 523 installed at a side of the shock-absorbing material receiver 520, the shock-absorbing material support plate 521 is opened when the shock-absorbing material support plate 521 is moved down from shock-absorbing material receiver 520 and a packaging box B is stopped on a conveyer.

Further, the present invention relates to (9) the shock-absorbing material supply apparatus that is used for an article packaging device of (8) in which the shock-absorbing material guide 530 is installed to be able to move up and down to correspond to the height of a packaging box B stopped on the conveyer C by a second LM guide 531 installed at a side of the shock-absorbing material guide 530.

Further, the present invention relates to (10) the shock-absorbing material supply apparatus that is used for an article packaging device of (8) in which the shock-absorbing material support plate 522 is controlled to move up and down such that the volume of the shock-absorbing material receiver 520 depending on movement of the shock-absorbing material support plate 522 becomes the same as the volume of an empty internal space of a packaging box B stopped on the conveyer.

### Advantageous Effects of Invention

According to the present invention, the volumes of empty packaging boxes randomly supplied to a conveyer and the volumes of articles to be put in the empty packaging boxes are calculated in advance and input to a controller, whether the empty volumes of the packaging boxes with the articles therein calculated on the basis of the input values in the controller and the empty spaces of the packaging boxes with the articles therein actually measured on the conveyer are the same is examined, and calculated amounts of shock-absorbing materials are supplied to the empty volumes of the packaging boxes. Accordingly, shock-absorbing materials can be accurately supplied.

Further, according to the present invention, since the components that manufacture and supply shock-absorbing materials are integrated, there is no need for a facility that moves shock-absorbing materials as in Korean Patent Application No. 2017-0138335, so the configuration for supplying shock-absorbing materials can be simplified.

Further, according to the present invention, the shock-absorbing material supply path is closed after a predetermined amount of shock-absorbing materials is supplied, so an accurate amount of shock-absorbing materials can be supplied.

Further, according to the present invention, the speed of supplying shock-absorbing materials into an empty space of a packaging box is improved by providing a first hopper and a second hopper, and the precision of the supply amount of shock-absorbing materials is improved by adding a blade cover of the second hopper.

### BRIEF DESCRIPTION OF DRAWINGS

FIG. 1 is a conceptual view of an article packaging device to which the present invention is applied.

FIG. 2 is a plan view of a conveyer line having three article packaging devices to which the present invention is applied.

FIG. 3 is a front view of a shock-absorbing material supply apparatus of the present invention.

FIG. 4 is a side view of the shock-absorbing material supply apparatus of the present invention.

FIG. 5 is a partial side view of the shock-absorbing material supply apparatus of the present invention.

FIG. 6 is a cross-sectional view of a first hopper of the present invention.

FIG. 7 is a cross-sectional view of the shock-absorbing material supply apparatus of the present invention.

FIG. 8 is a cross-sectional view of a second hopper of the present invention.

FIG. 9 is a side view of blades of the present invention.

### DESCRIPTION OF EMBODIMENTS

Exemplary embodiments of the present invention are described hereafter in detail with reference to the drawings.

The present invention relates to a shock-absorbing material supply apparatus that is used for an article packaging device that packages a shock-absorbing material in an empty internal space of a packaging box B with an article therein. The shock-absorbing material supply apparatus includes: a shock-absorbing material manufacturing device 410 manufacturing a shock-absorbing material; a first hopper 420 installed under the shock-absorbing material manufacturing device 410 and keeping manufactured shock-absorbing materials; a shock-absorbing material supply conveyer 430 installed under the first hopper 420 and supplying a predetermined amount of shock-absorbing materials to a second hopper 510; a shock-absorbing material receiver 520 being supplied with the shock-absorbing materials stored in the second hopper 510; and a shock-absorbing material guide 530 guiding the shock-absorbing materials received in the shock-absorbing material receiver 520 to empty internal spaces of packaging boxes B.

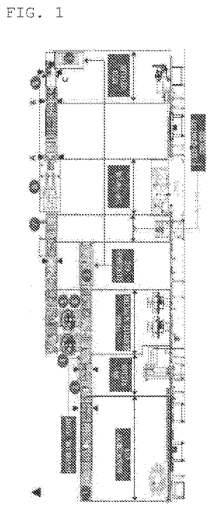

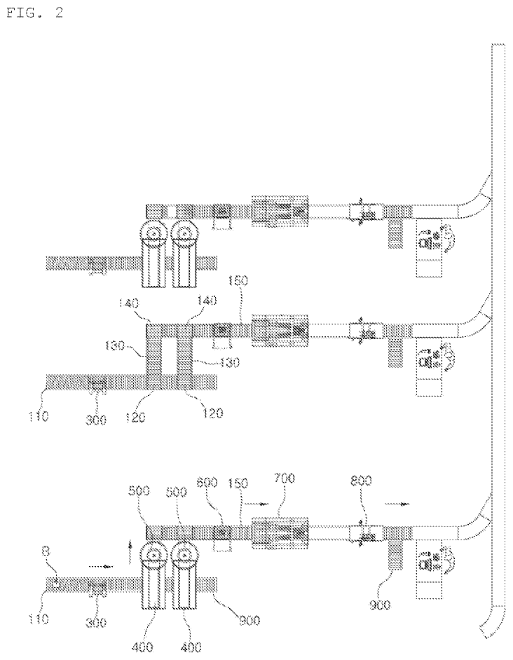

FIGS. 1 and 2 show an article packaging device to which the present invention is applied. The present invention relates to a shock-absorbing material supply apparatus indicated by reference numerals 400 and 500 of the article packaging device, and components are separately described hereafter with reference to FIGS. 3 to 9.

[Shock-Absorbing Material Manufacturing Device 410]

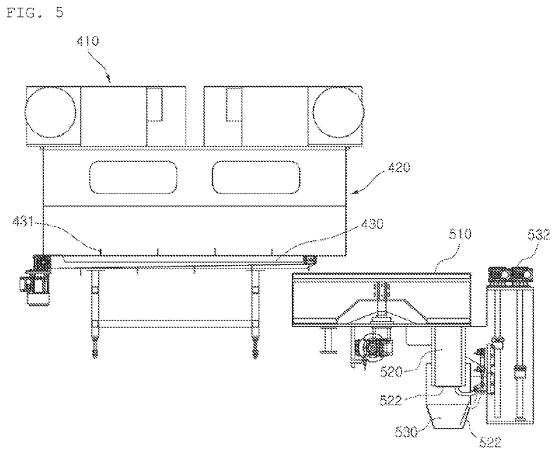

As shown in FIGS. 5 and 6, the shock-absorbing material manufacturing device 410 of the present invention is installed over the first hopper 420 to be described below. Several shock-absorbing material manufacturing devices 410 may be installed to be able to manufacture a large amount of shock-absorbing materials at once. As described above, by manufacturing and storing a large amount of shock-absorbing materials, it is possible to quickly supply a sufficient amount of shock-absorbing materials to packaging boxes B on a conveyer C.

The shock-absorbing material that is used in the present invention, for example, may be formed like an air capsule. However, the shock-absorbing material that is used in the present invention is not limited to the air capsule.

[First Hopper 420]

As shown in FIGS. 3 to 6, the first hopper 420 of the present invention is installed under the shock-absorbing material manufacturing device 410. This is because the arrangement is convenient in that the shock-absorbing material manufactured by the shock-absorbing material manufacturing device 410 can be naturally dropped and stored.

Sensor holes are installed to be vertically elongated on the front and rear of the first hopper 420 and first sensors S1 are installed at three positions of the top, middle, and bottom. The first sensors S1 may be a projection/receiving photo sensor. That is, the first sensors S1 may be turned on when a shock-absorbing material is sensed in the first hopper 420 and may be turned off when a shock-absorbing material is not sensed. The turning-on/off is transmitted to a separate controller so that the entire article packaging device to which the present invention is applied can be generally controlled.

For example, when there is no shock-absorbing material in the first hopper 420, not only the lowermost first sensor S1 at the bottom, but the first sensor S1 at the middle and the first sensor S1 at the top are turned off. Accordingly, it is determined that there is no shock-absorbing material in the first hopper 420 and this information is transmitted to a separate controller, whereby the operation of the article packaging device to which the present invention is applied is stopped. Further, the shock-absorbing material manufacturing device 410 may be controlled to operate.

Next, a case may be considered where the lowermost first sensor S1 at the bottom of the first sensors S1 is turned on and the first sensor S1 at the middle and the first sensor S1 at the top are turned off. In this case, it is determined that the first hopper 420 is filled under the middle portion, so the article packaging device to which the present invention is applied is operated with the shock-absorbing material manufacturing device 410 kept operating such that shock-absorbing materials can be supplied into the first hopper 420.

Further, a case may be considered where the lowermost first sensor S1 at the bottom of the first sensors S1 and the first sensor S1 at the middle are turned on and only the first sensor S1 at the top is turned off. In this case, it is determined that the first hopper 420 is filled over the middle portion, so the article packaging device to which the present invention is applied is operated with the shock-absorbing material manufacturing device 410 kept operating such that shock-absorbing materials can be supplied into the first hopper 420.

Further, a case may be considered where all the first sensor S1 at the bottom the first sensor S1 at the middle, and the first sensor S1 at the top of the first sensors S1 are turned on. In this case, it is determined that the first hopper 420 is filled up to the top, so the article packaging device to which the present invention is applied is operated with the shock-absorbing material manufacturing device 410 stopped.

The operation of the article packaging device based on turning-on/off of the first sensors S1 is applied in the same way to second sensors S2 and third sensors S3.

[Shock-Absorbing Material Supply Conveyer 430]

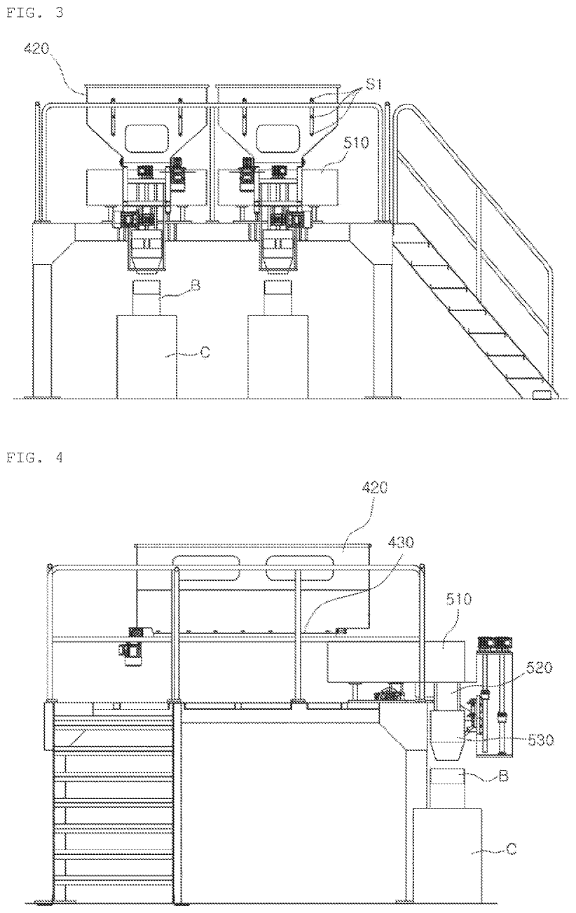

As shown in FIGS. 4 to 6, the shock-absorbing material supply conveyer 430 supplies the shock-absorbing materials stored in the first hopper 420 to the second hopper 510 to be described below. The shock-absorbing material supply conveyer 430 has guide plates 431 disposed with regular intervals such that a predetermined amount of shock-absorbing materials are separately conveyed to the second hopper 510. For example, if the amount of shock-absorbing materials that can be accommodated between guide plates 431 is 10, ten shock-absorbing materials are conveyed when one guide plate 431 of the shock-absorbing material supply conveyer 430 is conveyed.

The shock-absorbing material supply conveyer 430 is controlled by a separate controller. For example, the operation of the shock-absorbing material supply conveyer 430 is controlled on the basis of information about the second hopper 510 to be described below and the size of empty internal space of a packaging box B, whereby a predetermined amount of shock-absorbing materials can be supplied.

[Second Hopper 510]

As shown in FIGS. 3 to 5, the second hopper 510 stores the shock-absorbing materials supplied from the shock-absorbing material supply conveyer 430 and supplies a predetermined amount of shock-absorbing materials to the shock-absorbing material receiver 520 to be described below.

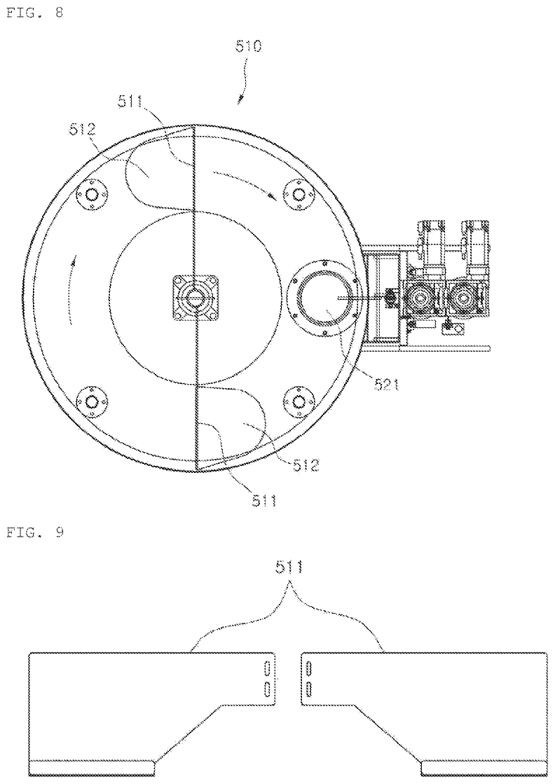

As shown in FIG. 8, the second hopper 510 has a blade 511 and a blade cover 512 therein. Although the second hopper 510 is divided into two sections by installing the blade 511 at both sides of shaft in an embodiment of the present invention as shown in FIGS. 8 and 9, the present invention does not limit the number of the blades 511, and three or more blades may be installed.

As shown in FIG. 8, the blade cover 512 having a sufficient size that can cover the top inlet 521 of the shock-absorbing material receiver 520 is attached to the blade 511 in an L-shape behind and under the blade 511 with respect to the rotational direction of the blade 511.

Since the blade cover 512 is attached to the blade 511 as described above, the shock-absorbing material supplied from the shock-absorbing material supply conveyer 430 is stored at a side of the second hopper 510 divided by the blade 511. Accordingly, as the blade 511 is rotated, the stored shock-absorbing material is pushed into the top inlet 521 of the shock-absorbing material receiver 520 and the blade cover 512 covers the top inlet 521 of the shock-absorbing material receiver 520 to prevent the shock-absorbing material stored at the other side other than the shock-absorbing material stored at a side of the second hopper 510 from being pushed into the shock-absorbing material receiver 520.

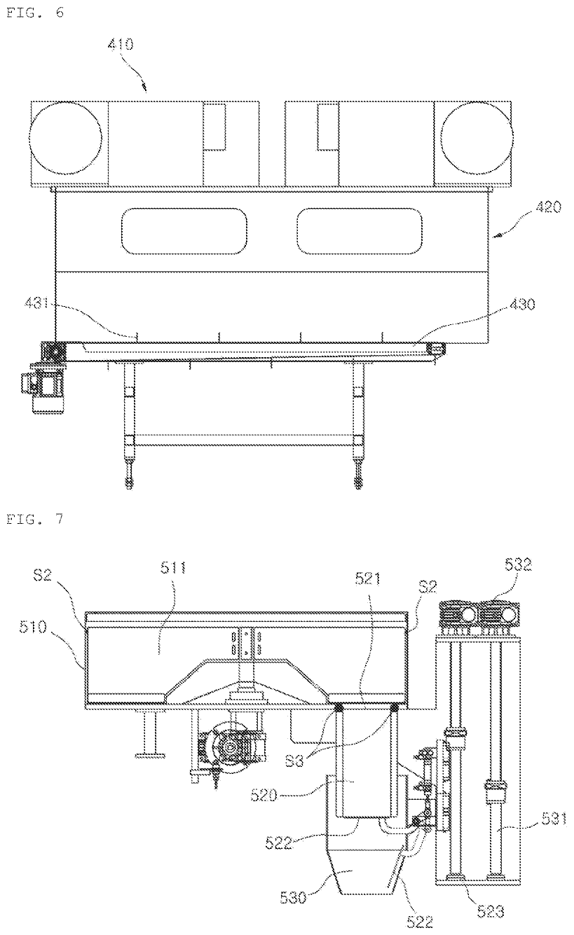

As shown in FIG. 7, second sensors S2 are installed at the upper portion of the second hopper 510. The second sensors S2 are turned on when shock-absorbing materials are excessively supplied from the shock-absorbing material supply conveyer 430, that is, when the second hopper 510 is fully filled with shock-absorbing materials, and in this case, the shock-absorbing material supply conveyer 430 is controlled to stop by a separate controller.

[Shock-Absorbing Material Receiver 520]

As shown in FIGS. 4, 5, and 7, the shock-absorbing material receiver 520 receives and keeps the shock-absorbing materials stored in the second hopper 510, that is, receives shock-absorbing materials from the second hopper 510 through the top inlet 521 that communicates with the second hopper 510.

The shock-absorbing material receiver 520 has a shock-absorbing material support plate 522 at the bottom and the shock-absorbing material support plate 522 adjusts the space that can accommodate shock-absorbing materials by moving up and down. The shock-absorbing material support plate 522 moves up and down to correspond to the empty internal space of the packaging box B stopped on the conveyer C under the shock-absorbing material guide 530.

The up-down movement of the shock-absorbing material support plate 522 is controlled by a separate controller.

The shock-absorbing material support plate 522 is vertically moved up and down according to a sub-motor and a first LM guide 523 installed at a side of the shock-absorbing material receiver 520.

As shown in FIGS. 4, 5, and 7, the shock-absorbing material received in the shock-absorbing material receiver 520 is supplied to packaging box B stopped on the conveyer C through the shock-absorbing material guide 530 to be described below by opening the shock-absorbing material support plate 522.

As shown in FIG. 7, third sensors S3 are installed at the top of the shock-absorbing material receiver 520. The third sensors S3 sense the supply of shock-absorbing materials. When the third sensors S3 do not sense the supply of a shock-absorbing material, that is, when shock-absorbing materials are not supplied up to the positions of the third sensors S3, it means that shock-absorbing materials are not normally supplied. Accordingly, the third sensors S3 are provided to show this abnormal state.

That is, when the third sensors S3 are turned off, it means that the shock-absorbing material receiver 520 is not filled with shock-absorbing materials, so the operation of the article packaging device to which the present invention is applied is stopped.

[Shock-Absorbing Material Guide 530]

As shown in FIGS. 5 and 7, the shock-absorbing material guide 530 is provided to guide shock-absorbing materials supplied from the shock-absorbing material receiver 520 to packaging boxes B while covering the outer side of the shock-absorbing material receiver 520.

The shock-absorbing material guide 530 guides shock-absorbing material to packaging boxes B while moving up and down.

For example, depending on the heights of packaging boxes B, that is, when the height of a packaging box is high, the shock-absorbing material guide 530 is moved up such that the bottom ascends, and when the height of a packaging box B is low, the shock-absorbing material guide 530 is moved down such that the bottom descends in order to prevent the shock-absorbing materials supplied from the shock-absorbing material receiver 520 from being dropped outside.

This is because when a shock-absorbing material is an air capsule, the shock-absorbing material itself is light, so a space should not be formed between the shock-absorbing material receiver 520 and the shock-absorbing material guide 530. The bottom of the shock-absorbing material receiver 520 and the top of the shock-absorbing material guide 530 may always overlap each other.

In other words, the shock-absorbing material guide 530 is controlled such that the top always covers the shock-absorbing material receiver 520 and the bottom can be positioned inside the wings of a packaging box B stopped on the conveyer C.

The shock-absorbing material guide 530, similar to the shock-absorbing material receiver 520, is vertically moved up and down by a sub-motor and a second LM guide 531 installed at a side of the shock-absorbing material guide 530.

The above description is provided as an example of the present invention and the embodiments described herein are provided to describe the present invention rather than limiting the spirit of the present invention, so the present invention may be changed and modified in various ways by those skilled in the art without departing from the scope of the present invention. Accordingly, the protective range of the present invention should be construed on the basis of claims and the contents in the equivalent range should also be construed as being included in the range of the present invention.

### REFERENCE SIGNS LIST

B: packaging box
C: conveyer
410: shock-absorbing material manufacturing device
420: first hopper
S1: first sensor
430: shock-absorbing material supply conveyer
510: second hopper
S2: second sensor
511: blade
512: blade cover
520: shock-absorbing material receiver
521: top inlet
522: shock-absorbing material support plate
523: first LM guide
S3: third sensor
530: shock-absorbing material guide
531: second LM guide

1. A shock-absorbing material supply apparatus that is used for an article packaging device that packages a shock-absorbing material in an empty internal space of a packaging box with an article therein, the shock-absorbing material supply apparatus comprising:
a shock-absorbing material manufacturing device manufacturing a shock-absorbing material;
a first hopper installed under the shock-absorbing material manufacturing device and keeping manufactured shock-absorbing materials;
a shock-absorbing material supply conveyer installed under the first hopper and supplying a predetermined amount of shock-absorbing materials to a second hopper;
a shock-absorbing material receiver being supplied with the shock-absorbing materials stored in the second hopper; and
a shock-absorbing material guide guiding the shock-absorbing materials received in the shock-absorbing material receiver to empty internal spaces of packaging boxes.

2. The shock-absorbing material supply apparatus of claim 1, wherein the shock-absorbing material supply conveyer has guide plates disposed with regular intervals such that a predetermined amount of shock-absorbing materials are separately conveyed to the second hopper.

3. The shock-absorbing material supply apparatus of claim 2, wherein the second hopper is divided by several blades and a blade cover having a sufficient size that can cover a top inlet of the shock-absorbing material receiver is installed behind and under the blade.

4. The shock-absorbing material supply apparatus of claim 3, wherein the shock-absorbing material guide has an upper portion that is larger in area than the shock-absorbing material receiver and a lower portion that is smaller than the area of the top of a packaging box such that all of shock-absorbing materials can be guided to the packaging box from the shock-absorbing material receiver.

5. The shock-absorbing material supply apparatus of claim 1, wherein several first sensors are installed up and down on a side of the first hopper and the first sensors measure the amount of shock-absorbing materials stored in the first hopper, show the amount to the outside, and transmit the amount to a controller.

6. The shock-absorbing material supply apparatus of claim 1, wherein second sensors are installed on a side of the upper portion of the second hopper and, when shock-absorbing materials are supplied up to the top of the second hoper, the second sensors are turned on transmit a turning-on signal to a controller to stop the shock-absorbing material conveyer.

7. The shock-absorbing material supply apparatus of claim 1, wherein third sensors are installed on a side of the upper portion of the shock-absorbing material receiver and, when shock-absorbing materials are not received up to the top of the shock-absorbing material receiver, the third sensors are turned off and transmit a turning-off signal to a controller to stop operation of the article packaging device.

8. The shock-absorbing material supply apparatus of claim 1, wherein the shock-absorbing material receiver is formed in a cylindrical shape,
a shock-absorbing material support plate moving up and down is installed inside the shock-absorbing material receiver,
the shock-absorbing material support plate is moved up and down by a first LM guide installed at a side of the shock-absorbing material receiver,
the shock-absorbing material support plate is opened when the shock-absorbing material support plate is moved down from shock-absorbing material receiver and a packaging box is stopped on a conveyer.

9. The shock-absorbing material supply apparatus of claim 8, wherein the shock-absorbing material is installed to be able to move up and down to correspond to the height of a packaging box stopped on the conveyer by a second LM guide installed at a side of the shock-absorbing material guide.

10. The shock-absorbing material supply apparatus of claim 8, wherein the shock-absorbing material support plate is controlled to move up and down such that the volume of the shock-absorbing material depending on movement of the shock-absorbing material support plate becomes the same as the volume of an empty internal space of a packaging box stopped on the conveyer.
